(19) United States
(12) Patent Application Publication
(10) Pub. No.: US 2014/0232738 A1
(43) Pub. Date: Aug. 21, 2014

(54) PROJECTION CORRECTING SYSTEM AND METHOD, AND PROJECTOR

(71) Applicant: NEC DISPLAY SOLUTIONS, LTD., Tokyo (JP)

(72) Inventors: Michio Tomizawa, Tokyo (JP); Koichi Ara, Tokyo (JP); Atsuhiko Saitou, Tokyo (JP)

(21) Appl. No.: 14/347,211

(22) PCT Filed: Sep. 26, 2011
(86) PCT No.: PCT/JP2011/071897

§ 371 Date: Mar. 25, 2014

(51) Int. Cl. G06T 5/00; G09G 5/37

(52) U.S. Cl. CPC G06T 5/00; G06T 5/006; G09G 5/37
USPC 345/590

(57) ABSTRACT

The purpose of the present invention is to carry out, simply and reliably, distortion correction and uneven brightness correction, and includes a memory for blending data; a memory for geometric correction data; an image correcting unit; and a CPU which, upon receiving two-dimensional correction data representing the contents of geometric correction data for performing distortion correction and blending data for performing brightness correction, creates the blending data and the geometric correction data based on the two-dimensional correction data, stores the data into the memory for blending data and into the memory for geometric correction data, refers, as regards the input image signal, to the stored contents in the memory for blending data and the memory for geometric correction data and causes the image correcting unit to perform distortion correction and uneven brightness correction in accordance with the stored contents.

### TECHNICAL FIELD

The present invention relates to a projector correcting system and method, as well as to a projector, which, when a plurality of projectors are used for projection, corrects the brightness and distortion of projected images of individual projectors.

### BACKGROUND ART

There has been a videowall system, which forms a single image from projected images of a plurality of projectors. In this videowall system, brightness correction and distortion correction made on the projected images of individual projectors will be described hereinbelow.

FIG. 1 is a diagram showing a schematic configuration of a system for projecting a large image by combining the images projected from two projectors, side by side.

When projected image 11 projected by projector 1, shown by the thick line and projected image 12 projected by projector 2, shown by the solid line, are laid over each other, image area 13 in which the image is actually displayed, and which extends over the two projected image areas, is shown by the broken line.

As shown in FIG. 1, projected image 11 of projector 1 that is arranged on the left side relative to image area 13 and directed diagonally forward right, becomes enlarged toward the right, whereas projected image 12 of projector 2 that is arranged on the right side relative to image area 13 and directed diagonally forward left, becomes enlarged toward the left. For this reason, the brightness of projected images 11 and 12 when a uniform image is projected will not be uniform, depending on the positions along the horizontal direction in the drawing.

Further, in image area 13 there is a region on which the two projectors 1 and 2 project images at the same time. This region presents markedly higher brightness than that in the region projected by only one of the projectors.

It is possible to eliminate the distortion and uneven brightness that occur in the above projected images 11 and 12, by setting projectors 1 and 2 at a standard position to the screen. However, in the situation where a large screen videowall system is used, the projectors are often arranged close to the screen to prevent people and objects that might interfere with the projection from standing between the projectors and the screen. Further, even if projectors are arranged at a standard distance from the screen, it is impossible to completely eliminate distortion and uneven brightness. As a result, the projected images of the projectors that form a videowall system end up having the above-described distortion and uneven brightness.

FIG. 2 shows the same projected image areas and images as in FIG. 1, clarifying projected image area 21 formed by projector 1 alone, projected image area 22 formed by projector 2 alone, and overlap area 23 where the projected image areas of projectors 1 and 2 overlap, in image area 13.

FIG. 3 is a diagram showing a projected image of the image signal supplied to projector 1.

The projected images formed by projectors 1 and 2 are based on the image signals supplied from a computer or video equipment such as a DVD player (Digital Versatile Disc Player). The image represented by the image signal presents a rectangular image as shown in FIG. 3 when the projector is arranged at a standard position to the screen. As described above, in the videowall system using multiple projectors, the projected image from each projector is accompanied with distortion and uneven brightness as shown in FIGS. 1 and 2, so that an image signal that produces the image shown in FIG. 3 by canceling distortion and uneven brightness is supplied.

In FIG. 3, the area in which the image is actually displayed is formed of projected image area 21 and overlap area 23, whereas no displayed image is needed in the other areas 31 to 34, so that geometric correction is implemented on the computer. Further, for overlap area 23 that overlaps the projected image of projector 2, brightness correction is also implemented.

Since the shape of area 23 varies depending on the setting condition, brightness correction data is generally created in the form of two-dimensional data.

As to the amount of data, when the quality of an image is lowered and when two-dimensional correction is applied, it is usual to store image data into memory for alpha blending. When alpha data is 8 bits and the resolution is 1024 dots horizontally and 768 lines vertically, the data amounts to 1,024×768×8=6,291,456 bits=786,432 bytes.

As a technology for alleviating the above-described uneven brightness, Patent Document 1 (JP2007-58425A) discloses a technology for adjusting the brightness level of the image signal being projected.

In order to provide a technology that enables the display of a single frame by using a plurality of projectors and that uses a simple and low cost method, Patent Document 1 discloses a projector comprising: a capture unit for receiving and capturing image signals including a blending area corresponding to the overlap region and the quantity of blending data as the mask image, from a personal computer; and an image adjusting unit for reflecting the gain obtained from the mask image on the image to be projected by use of the alpha blending function.

The specific image adjustment disclosed in Patent Document 1 is as follows:
1. Project images of the first and second projectors and perform distortion correction;
2. Perform calibration of the images of the first and second projectors;
3. Project images for adjustment from the first and second projectors;
4. As to the shape of the mask image, or the region to be gradated, identify the shape of the mask image corresponding to the image for first projector adjustment while checking the image for adjustment using a personal computer, and apply gradation; then, similarly the user identifies the shape of the mask image corresponding to the image for second projector adjustment and applies gradation;
5. Adjust the gradation of each of the mask images for first and second projector adjustment so that the brightness becomes uniform over the entire frame of the display being projected;
6. The capture unit of each projector captures the adjusted mask image; and,
7. The capture unit of each projector converts the brightness data of the captured mask image into a gain adjustment map.

### RELATED ART DOCUMENT

Patent Document 1: JP2007-58425A

### Disclosure of the Invention

### Problems to be Solved by the Invention

In the invention disclosed in Patent Document 1, the images for adjustment are projected after performing distortion correction, then correction based on this is performed. In this way, distortion correction and uneven brightness correction are performed separately, so a lot of time is needed for adjustment.

Correction of uneven brightness is performed for the region of the mask image (overlap area 23 in FIGS. 2 and 3, of the present application) only. As stated above, the uneven brightness when distortion correction has been generated is different depending on the position along the horizontal direction in the drawing, in the case of FIG. 2 of the present application, so that uneven brightness correction for only the overlap region is imperfect.

The present invention is to perform distortion correction and uneven brightness correction more easily and reliably.

### Means for Solving the Problems

The projector correcting system of the present invention resides in a projector correcting system which, when a plurality of projectors perform projection, corrects distortion and brightness for each projector, comprising:

a camera for photographing the projected images of the plural projectors; and

a computer which sets up contents to be displayed by the plural projectors, actuates the camera to photograph the displayed contents, acquires from the result of the photographed images, geometric correction data for correcting distortion and blending data for performing brightness correction for each of the plural projectors, creates two-dimensional correction data representing the contents and transmits the two-dimensional correction data to each of the plural projectors, characterized in that

the plural projectors each include:

a memory for blending data;

a memory for geometric correction data;

an image correcting unit; and

a CPU which, based on the two-dimensional correction data from the computer, creates the blending data and the geometric correction data, stores the data into the memory for blending data and the memory for geometric correction data, refers, as regards the input image signal, to the stored contents in the memory for blending data and the memory for geometric correction data and causes the image correcting unit to perform distortion correction and uneven brightness correction in accordance with the stored contents.

The projector correcting method of the present invention resides in a projector correcting method used in a projector correcting system including a camera that, when a plurality of projectors performs projection, photographs the projected images of the plural projectors in order to perform distortion correction and brightness correction for each projector, and is characterized in that

a computer sets up contents to be displayed by the plural projectors, actuates the camera to photograph the displayed content, acquires from the result of the photographed images, geometric correction data for correcting distortion and blending data for to perform brightness correction for each of the plural projectors, creates two-dimensional correction data representing the contents and transmits the two-dimensional correction data to each of the plural projectors, and

each of the plural projectors, based on the two-dimensional correction data from the computer, creates the blending data and the geometric correction data, and performs distortion correction and uneven brightness correction on the input image signal in accordance with the blending data and the geometric correction data.

The projector of the present invention includes:

a memory for blending data;

a memory for geometric correction data;

an image correcting unit; and

a CPU which, upon receiving two-dimensional correction data representing the contents of geometric correction data for performing distortion correction and blending data in order to execute brightness correction, creates the blending data and the geometric correction data based on the two-dimensional correction data, stores the data into the memory for blending data and the memory for geometric correction data, refers, as regards the input image signal, to the stored contents in the memory for blending data and the memory for geometric correction data and causes the image correcting unit to perform distortion correction and uneven brightness correction in accordance with the stored contents.

### Effect of the Invention

In the present invention configured as above, distortion correction and uneven brightness correction can be performed more easily and reliably.

### BRIEF DESCRIPTION OF THE DRAWINGS

FIG. 1 is a diagram showing a schematic configuration of a system of combining projected images from two projectors, side by side to project a large image.

FIG. 2 shows the same projected image areas and images as in in FIG. 1, explicating projected image area 21 formed only by projector 1, projected image area 22 formed by projector 2 alone, and overlap area 23 where the projected image areas of projectors 1 and 2 overlap, in image area 13.

FIG. 3 is a diagram showing a projected image of the image signal supplied to projector 1.

FIG. 4 is a block diagram showing a configuration of one exemplary embodiment of a projector correcting system according to the present invention.

FIG. 5 is a block diagram showing an essential configuration of projectors 100₁ to 100ₙ.

FIG. 6 is a flow chart showing the operation as to distortion correction and uneven brightness correction of the exemplary embodiment of the present invention.

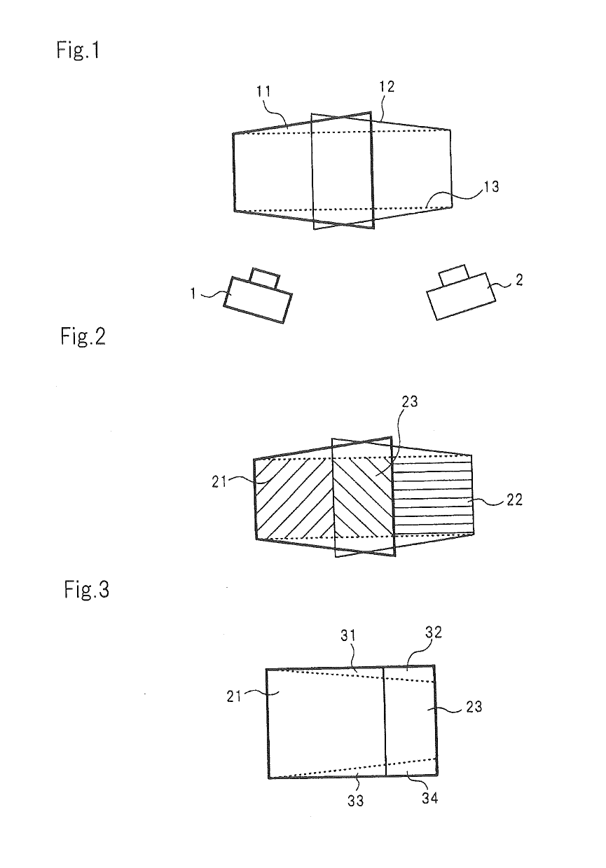

### THE BEST MODE FOR CARRYING OUT THE INVENTION

Next, the exemplary embodiment of the present invention will be described with reference to the drawings.

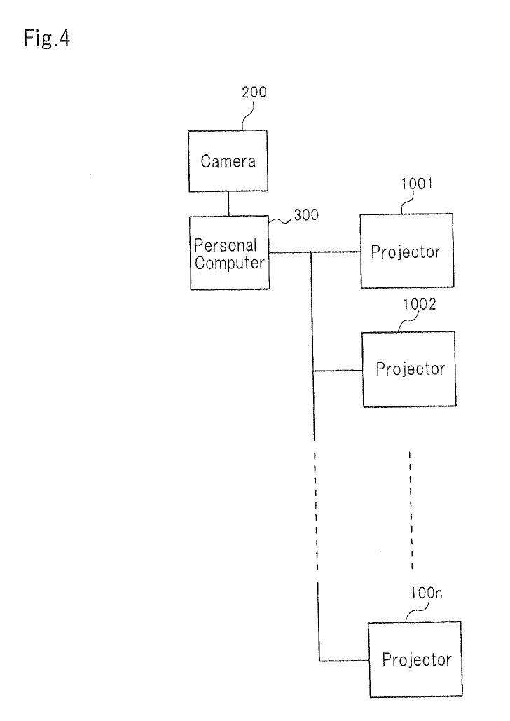

FIG. 4 is a block diagram showing a configuration of one exemplary embodiment of a projector correcting system according to the present invention. This exemplary embodiment is composed of a plurality of projectors 100₁, 100₂ . . . 100ₙ that constructs a videowall system, and personal computer 300 connected to each of projectors 100₁ to 100ₙ and camera 200 to control operations of these projectors.

Personal computer 300 detects the relative position of each of projectors 100₁ to 100ₙ to the screen, based on the photographed content of camera 200, calculates geometric data and blending regions in accordance with the detected result so as to create two-dimensional correction data that represents the image as shown in FIG. 3, which each projector should project, and distributes the data to each projector. The two-dimensional correction data may use an image format such as BMP (Bit MaP) for convenience.

Each projector, based on the two-dimensional correction data delivered from personal computer 300, adjusts the projected image and projects the adjusted one.

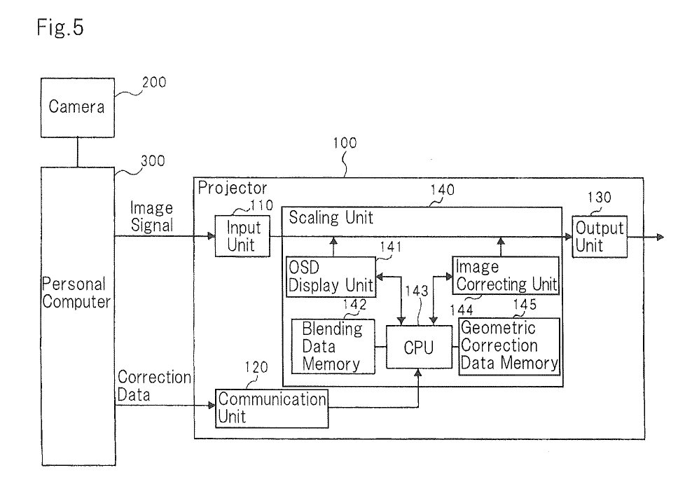

FIG. 5 is a block diagram showing an essential configuration of projectors 100₁ to 100ₙ. In FIG. 5, the projector connected to personal computer 300 is represented by projector 100, and a situation in which personal computer 300 is connected to only one projector is shown. Though projector 100 actually should be equipped with a projection optical system, FIG. 5 shows only the image signal processing system related to the present invention.

Projector 100 includes input unit 110, commutation unit 120, output unit 130 and scaling unit 140. Scaling unit 140 includes OSD (On-Screen Display) display unit 141, blending data memory 142, CPU (Central Processing Unit) 143, image correcting unit 144 and geometric correction data memory 145.

CPU 143, based on the two-dimensional correction data sent from personal computer 300 via communication unit 120, creates geometric correction data for performing distortion correction and stores the data into geometric correction data memory 145. CPU 143 also creates blending data for performing uneven brightness correction, based on the two-dimensional correction data sent from personal computer 300 via communication unit 120, and stores the data into blending data memory 142.

The geometric correction data indicates, by using the regions shown in FIG. 3, regions 31 to 34 for which no image display is needed. The blending data indicates correction values for projected image area 21 and overlap area 23 whose uneven brightness needs to be corrected.

CPU 143 causes OSD display unit 110 to perform OSD display for the image signal sent from personal computer 300 via input unit 110. The CPU, referring to the stored contents in blending data memory 142 and geometric correction data memory 145, causes image correcting unit 144 to perform distortion correction and uneven brightness correction in accordance with these stored contents. The image signal having been subjected to these processes is sent to output unit 130 and supplied to the display unit (not shown) constituting a projection optical system so that the image whose distortion and uneven brightness that has been corrected is projected.

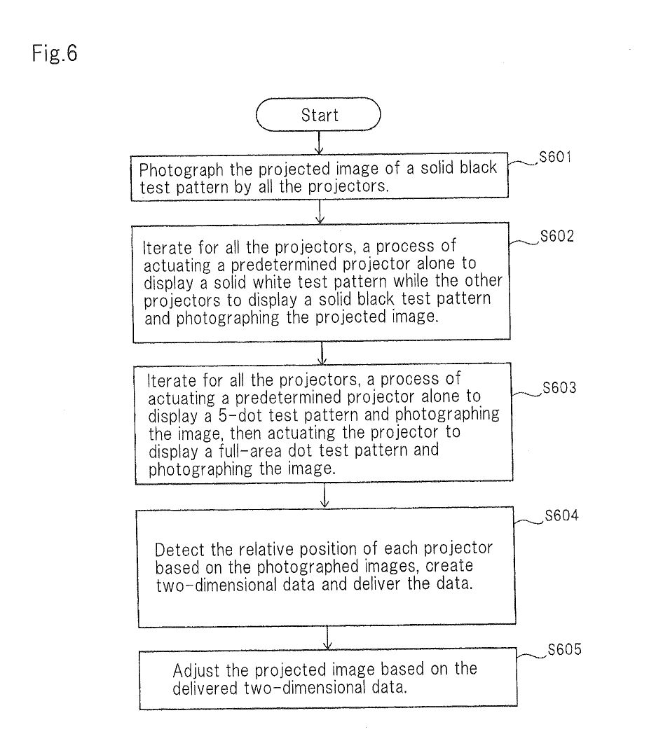

FIG. 6 is a flow chart showing the operation as to distortion correction and uneven brightness correction of the present exemplary embodiment.

When the operation is started, personal computer 300 actuates projectors 100₁ to 100ₙ to display a solid black test pattern and actuates camera 20 to photograph the image (Step S601).

Next, personal computer 300 actuates only projector 100₁ to display a solid white test pattern and the other projectors to display a solid black test pattern, and actuates camera 20 to photograph the image. This process is repeated one by one for all the projectors (Step S602). By comparison with the photographed content at Step 5601, the condition of uneven brightness of each projector can be understood.

Next, personal computer 300 actuates only projector 100₁ to display a 5-dot test pattern and actuates camera 20 to photograph the image, then actuates the projector to display a full-area dot test pattern and actuates camera 200 to photograph the image. This process is repeated one to another for all the projectors (Step S603). Herein, the 5-dot test pattern is a test pattern with predetermined dots displayed in the center and at the four corners of the projected image, whereas the full-area dot test pattern is a test pattern with dots evenly displayed over the entire projected image. Photographing these test patterns makes it possible to distinguish the contour and shape of the image projected by each projector and to understand the distortion condition.

Next, personal computer 300, based on the result of image taking at Steps S601 to S603, detects the relative position of each projector relative to the combined image area, obtains geometric correction data and blending data, creates two-dimensional data which represents the above content, or the image to be projected by each projector, as shown in FIG. 3, and delivers the data to each projector (Step S604).

Each projector adjusts the projected image based on the two-dimensional correction data sent from personal computer 300 and projects the adjusted image (Step S605).

Distortion correction and uneven brightness correction performed in this exemplary embodiment, is carried out once for one videowall system. Once the two-dimensional correction data has been distributed to each projector, distortion correction and uneven brightness correction based on the two-dimensional correction data is performed by each projector, so neither a person computer nor a camera are required to correct distortion and uneven brightness.

Image signals to the projectors are supplied from a computer or video equipment. In the case where correction is performed inside a computer, the correction can be made only to the image output from the computer; and in the case where video equipment supplies image signals, it is impossible to preform distortion correction and brightness correction. In the present exemplary embodiment configured as above, since distortion correction and brightness correction based on two-dimensional correction data are performed on the projector side, it is possible to perform distortion correction and brightness correction, regardless of the supply source of image signals.

Though in the above exemplary embodiment, the format of the two-dimensional correction data is assumed as BMP, a JPEG (Joint Photographic Experts Group) format may also be used. Use of a JPEG format makes it possible to reduce the data volume, shorten the transmission time of the two-dimensional correction data and achieve high-speed processing. Herein, though the JPEG format is compressed data that is irreversible, it is possible to avoid the limitation of irreversibility by incorporating the necessary 8-bit alpha data into the Y (luminance) component of the same 8-bits.

Alternatively, in view of compressing the data volume, it is possible to expect a similar result by adopting run-length encoding (RLE: Run Length Encoding). If a video is continuation of approximately the same patterns, run-length encoding produces a great result.

When the aforementioned JPEG format is used, or when run-length encoding is adopted, it is also possible to achieve high-speed processing by halving the resolution of the alpha data to be prepared, taking into account that the area for which computation is needed is determined based on the condition of the layout of the projectors.

In the case of a videowall system using two projectors, for example, from the relative positions between the first projector and the second projector, it is understood that the area to be subjected to blending correction in the first projector is the right half of the projected image. Therefore, by setting the resolution of the alpha data to be prepared, to be 512×768 instead of 1024×768, the data can be halved. Reduction of the data volume in this way makes it possible to enhance the speed of the conventional blending correction process.

In the present exemplary embodiment, since distortion correction data and blending data are acquired based on the two-dimensional correction data delivered from the personal computer, the image area for which distortion correction has been made and the image area for which blending correction has been made coincide clearly. In the invention described in cited document 1 and others in which distortion correction and blending are carried out separately, the two areas do not always coincide. As a result, there is a fear that the projected image after correction will become degraded. In contrast, in the present exemplary embodiment, the image area for which distortion correction has been performed and the image area for which blending correction has been made absolutely coincide, so that no degradation of the projected image after correction due to the discrepancy will occur.

By transmitting images for correction as files via the communication unit so as to store the files for every set condition for which correction has been performed, it is possible to quickly perform distortion correction and blending correction when the set condition is varied.

Generally, when oblique projection is carried out, the brightness of the projected image is inclined toward the direction in which distortion of the projected image spreads (explaining using FIG. 2 of cited document 1, the brightness becomes lower in the upward and rightward directions areas). In the present exemplary embodiment, distortion correction and blending adjustment are performed by photographing the entire projected image with a camera, so that it is possible to correct the component of brightness inclination due to oblique projection at the same time.

As another exemplary embodiment, instead of distributing two-dimensional correction data from the personal computer, the image after correction is output as an image signal so that the projector can capture the image as two-dimensional data. In this case, the projector can perform distortion correction and blending correction by capturing the image being displayed when distortion correction and blending correction by the personal computer are completed. It is hence possible to check the process of adjustment by visual observation.

### DESCRIPTION OF REFERENCE NUMERALS

100 projector
110 input unit
120 communication unit
130 output unit
140 scaling unit
141 OSD display unit
142 blending data memory

### 143 CPU

144 image correcting unit
145 geometric correction data memory
200 camera
300 personal computer

1. A projector correcting system which, when a plurality of projectors perform projection, performs distortion correction and brightness correction for each projector, comprising:
a camera for photographing the projected images of the plural projectors; and
a computer which sets up contents to be displayed by the plural projectors, actuates the camera to photograph the displayed contents, acquires from the result of the photographed images, geometric correction data for correcting distortion and blending data for performing brightness correction for each of the plural projectors, creates two-dimensional correction data representing the contents and transmits the two-dimensional correction data to each of the plural projectors, characterized in that
the plural projectors each include:
a memory for blending data;
a memory for geometric correction data;
an image correcting unit; and
a CPU which, based on the two-dimensional correction data from the computer, creates the blending data and the geometric correction data, stores the data into the memory for blending data and into the memory for geometric correction data, refers, as regards the input image signal, to the stored contents in the memory for blending data and the memory for geometric correction data and causes the image correcting unit to perform distortion correction and uneven brightness correction in accordance with the stored contents.

2. A projector correcting method used in a projector correcting system including a camera that, when a plurality of projectors performs projection, photographs the projected images of the plural projectors in order to perform distortion correction and brightness correction for each projector, characterized in that
a computer sets up contents to displayed by the plural projectors, actuates the camera to photograph the displayed content, acquires from the result of the photographed images, geometric correction data for correcting distortion and blending data for performing brightness correction for each of the plural projectors, creates two-dimensional correction data representing the contents and transmits the two-dimensional correction data to each of the plural projectors, and
each of the plural projectors, based on the two-dimensional correction data from the computer, creates the blending data and the geometric correction data, and performs distortion correction and uneven brightness correction on the input image signal in accordance with the blending data and the geometric correction data.

3. A projector includes:
a memory for blending data;
a memory for geometric correction data;
an image correcting unit; and
a CPU which, upon receiving two-dimensional correction data representing the contents of geometric correction data for performing distortion correction and blending data for performing brightness correction, creates the blending data and the geometric correction data based on the two-dimensional correction data, stores the data into the memory for blending data and into the memory for geometric correction data, refers, as regards the input image signal, to the stored contents in the memory for blending data and the memory for geometric correction data and causes the image correcting unit to perform distortion correction and uneven brightness correction in accordance with the stored contents.
